(19) United States
(12) Patent Application Publication
(10) Pub. No.: US 2010/0104685 A1
(43) Pub. Date: Apr. 29, 2010

(54) Device for processing elastomers and/or thermoplastics

(75) Inventor: Manfred Dufner, Krauchenwies (DE)

Correspondence Address: COLLARD & ROE, P.C., 1077 NORTHERN BOULEVARD, ROSLYN, NY, 11576, US

(73) Assignee: Kloeckner Desma Elastomertechnik GmbH

(21) Appl. No.: 12/589,790

(22) Filed: Oct. 28, 2009

(30) Foreign Application Priority Data
Oct. 29, 2008 (DE) 10 2008 053 712.8

(51) Int. Cl. B29C 45/18; B29C 45/22

(52) U.S. Cl. 425/547; 425/568; 425/570

(57) ABSTRACT

A device for processing elastomers or thermoplastics has a distribution system that is disposed between a plasticizing unit and an injection-molding die for distribution of the material plasticized in the plasticizing unit. At least one nozzle is disposed on the distribution system, by way of which nozzle the plasticized elastomer can be injected into the cavity of the injection molding die. The at least one nozzle is attached outside the center on a rotating insert, in each instance, which insert is disposed in a recess in the distribution system.

### CROSS REFERENCE TO RELATED APPLICATIONS

Applicants claim priority under 35 U.S.C. §119 of German Application No. 10 2008 053 712.8 filed Oct. 29, 2008.

### BACKGROUND OF THE INVENTION

1. Field of the Invention

The present invention relates to a device for processing elastomers and/or thermoplastics having a distribution system that is disposed between the plasticizing unit and an injection-molding die, for distribution of the material in the plasticizing unit, whereby at least one nozzle is disposed on the distribution system, by way of which nozzle the plasticized elastomer can be injected into the cavity of the injection-molding die. In particular, a so-called cold channel block is a distribution system that is supplied from a plasticizing unit, and applies material to one or more of the nozzles in question, by way of a channel system. The nozzles then inject the mass, which is still plastic, into corresponding mold cavities. In order for the plasticized mass to remain processable on its path from the plasticizing unit, through the channel system, to the nozzles, the cold channel block is provided with a corresponding tempering system in which a suitable tempering medium circulates.

2. The Prior Art

Up to the present, these cold channel blocks have been designed so that the cold channel nozzles are attached at a fixed position. Thus, each cold channel block, with its nozzle array, can be used only for specific mold dies. This drawback also holds true for thermoplastic heating distributors.

### SUMMARY OF THE INVENTION

In order to be more flexible here, a device for processing elastomers and/or thermoplastics is provided according to the invention having a distribution system wherein the at least one nozzle is attached outside the center on a rotating insert, in each instance, which insert is provided in a recess in the distribution system.

By rotating the insert, different positions of the nozzle are possible, and thus the operation of different dies under the same distribution system is possible.

In the simplest case, the rotating insert is a round disk on which the nozzle is disposed eccentrically, whereby the insert can be rotated about a specific angle, via a pivoting drive, by way of a corresponding gear mechanism.

Depending on the required injection-molding die and its geometry, in accordance with an embodiment of the invention, more than one rotating insert, with the nozzle assigned to it, is provided in the distribution system.

Thus, a multi-path injection system results.

In this connection, in accordance with an advantageous embodiment, all the nozzles can be pivoted synchronously toward one another or away from one another, respectively, using the pivoting drive, by way of the gear mechanism. In other words, intermediate positions between an extreme position in which the nozzles are disposed at a minimal distance from one another, and another extreme position in which the distance between the nozzles is maximal, can also be selected.

It is also possible that every nozzle can be pivoted into a position that is different from the others.

According to another advantageous embodiment of the invention, the nozzle or nozzles can be pivoted on its/their insert, in an arc-shaped segment that can also be completely round.

In another embodiment, these arc-shaped segments are provided in a symmetrical arrangement on the distribution system, and form an arc of 180° to 360°, in each instance. Here, four nozzles are provided, and a relatively large region can be covered by the four nozzles. The invention is not limited, however, to a maximum of four nozzles.

According to further embodiment, a thermoplastic heating distributor can be provided as a distribution system.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a cross-sectional view of a cold channel block showing details thereof; and

FIG. 2 is a perspective representation of an advantageous embodiment of the cold channel.

### DETAILED DESCRIPTION OF PREFERRED EMBODIMENTS

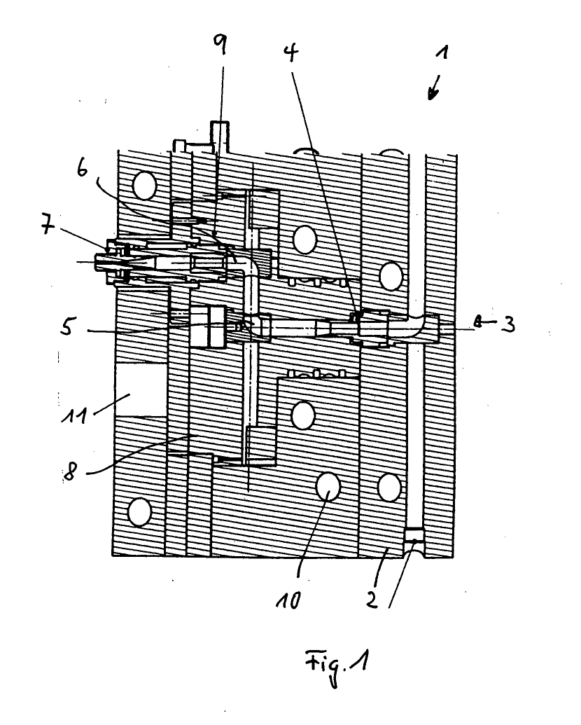

Turning now in detail to the drawings which present the invention using the example of a cold channel block, FIG. 1 shows details of a so-called cold channel block for processing elastomers, and is provided with the reference symbol 1. Cold channel block 1 consists of a plate 2, which faces the plasticizing unit, not shown, which unit is laid against the opening 3 of a channel 4 with the injection nozzle. Channel 4 runs all the way to a distributor 5, which is connected with at least one cold channel nozzle 7 by way of another channel 6; only one of these nozzles is shown in the drawing.

This nozzle 7 is situated on an insert 8 that is mounted in a recess 9 in cold channel block 1, so as to rotate, whereby cold channel nozzle 7 is disposed around and at a distance from the axis of rotation of insert 8.

Cold channel nozzle 7 is laid against the runner of an injection-molding die (not shown) during the injection-molding process.

For tempering of the cold channel block, tempering channels 10 are provided in the cold channel block.

Different positions of cold channel nozzle 7 are possible by rotating insert 8, and thus it is possible to operate different dies under the same cold channel 1.

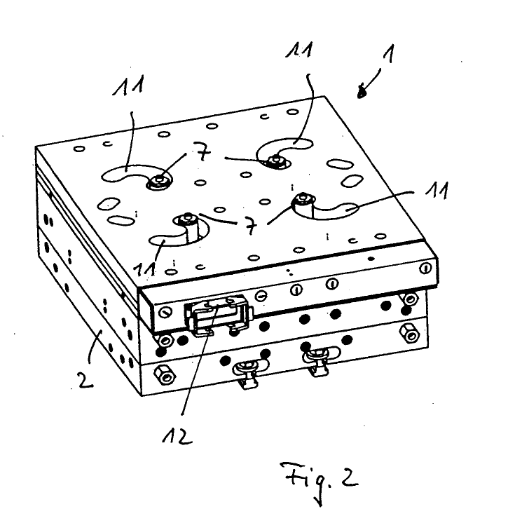

As is evident from FIG. 2, in a particular embodiment of the invention, it is provided that four nozzles 7 disposed symmetrical to one another are provided in cold channel block 1, which can be pivoted, in the case of this exemplary embodiment, in recesses 11 having the shape of 180° arcs.

The pivoting movement takes place using a drive 12 that acts on the corresponding inserts 8 by way of a gear mechanism, not shown, thereby making it possible to pivot the nozzles 7 from a position—as shown here—in which the nozzles have a minimal distance from one another, into a different position, in which the nozzles 7 have a maximal distance from one another. Intermediate positions can be adjusted without any steps.

Accordingly, although at least one embodiment of the present invention has been shown and described, it is to be understood that many changes and modifications may be made thereunto without departing from the spirit and scope of the invention.

What is claimed is:

1. A device for processing elastomers or thermoplastics comprising:
(a) a plasticizing unit;
(b) an injection-molding die comprising a cavity; and
(c) a distribution system disposed between the plasticizing unit and the injection-molding die for distribution of material plasticized in the plasticizing unit, said distribution system comprising at least one nozzle for injecting plasticized material into the cavity of the injection-molding die, at least one recess, and at least one rotating insert disposed in the at least one recess, said at least one nozzle being non-centrally attached to the at least one rotating insert.

2. The device according to claim 1, further comprising a pivoting drive connected to the at least one rotating insert by way of a gear mechanism.

3. The device according to claim 2, wherein the at least one rotating insert comprises a plurality of rotating inserts and the at least one nozzle comprises a plurality of nozzles, each rotating insert being associated with a respective nozzle of the plurality of nozzles.

4. The device according to claim 3, wherein all the nozzles are pivotable synchronously toward one another or away from one another, respectively, by use of the pivoting drive, by way of the gear mechanism.

5. The device according to claim 1, wherein the at least one nozzle is pivotable on the at least one insert in an arc-shaped to circular cut-out.

6. The device according to claim 1, wherein the at least one nozzle comprises first, second, third and fourth nozzles in a symmetrical arrangement on the distribution system, each nozzle being pivotable in a 180° to 360° arc without steps.

7. The device according to claim 1, wherein the distribution system is a thermoplastic heating distributor.

8. The device according to claim 1, wherein the distribution system is a cold channel block.
